(19) United States
(12) Patent Application Publication
(10) Pub. No.: US 2026/0103139 A1
(43) Pub. Date: Apr. 16, 2026

(54) HIGH PRESSURE AIR COMPRESSOR

(71) Applicant: Oshkosh Corporation, Oshkosh, WI (US)

(72) Inventor: Mark Jeffrey Wiest, Oshkosh, WI (US)

(73) Assignee: Oshkosh Corporation, Oshkosh, WI (US)

(21) Appl. No.: 19/357,840

(22) Filed: Oct. 14, 2025

Related U.S. Application Data
(60) Provisional application No. 63/707,612, filed on Oct. 15, 2024.

(51) Int. Cl. B60P 3/22; B60D 1/155; B60S 9/18; B60T 7/02; B62D 63/08; G05B 15/02

(52) U.S. Cl. CPC B60P 3/225; B60D 1/155; B60P 3/226; B60P 3/2265; B60P 3/228; B60S 9/18; B60T 7/02; B62D 63/08; G05B 15/02

(57) ABSTRACT

A high pressure air compressor system includes a trailer, a compressor assembly, a fuel assembly, a control panel, and an enclosure. The trailer includes a platform and a tractive assembly coupled to the platform. The compressor assembly is supported by the platform. The fuel assembly is coupled to the platform and fluidly coupled to the compressor assembly. The control panel communicably is coupled to the compressor assembly. The control panel is supported by the platform. The enclosure extends along the platform with the compressor assembly and the fuel assembly disposed therein.

### CROSS-REFERENCE TO RELATED PATENT APPLICATION

This application claims the benefit of and priority to U.S. Provisional Application No. 63/707,612, filed on Oct. 15, 2024, the entire disclosure of which is hereby incorporated by reference herein.

### BACKGROUND

High pressure air compressors typically use a series of processes to intake ambient air and pressurize that air for use in a variety of applications. Typical high pressure air compressors are often relatively large devices. These large high pressure air compressors can be difficult to transport, restricting the number of applications that the air compressor can be applied to.

### SUMMARY

One embodiment relates to a high pressure air compressor system. The high pressure air compressor system includes a trailer, a compressor assembly, a fuel assembly, a control panel, and an enclosure. The trailer includes a platform and a tractive assembly coupled to the platform. The compressor assembly is supported by the platform. The fuel assembly is coupled to the platform and fluidly coupled to the compressor assembly. The control panel communicably is coupled to the compressor assembly. The control panel is supported by the platform. The enclosure extends along the platform with the compressor assembly and the fuel assembly disposed therein.

Another embodiment relates to an air compressor system. The air compressor system includes a platform including a front end and a rear end, a tractive assembly, a compressor assembly, a control system, an enclosure, a towing arm, a side-folding hinge, and a manual brake. The compressor assembly includes a compressor, an air driver, a prime mover, a conduit, and a reel. The compressor assembly generates and provides pressurized air. The control system includes a control panel configured to provide the user with the ability to control the air compressor system. The enclosure houses the compressor assembly. The towing arm is pivotably coupled to the front end of the platform and the side-folding hinge facilitates rotation of the towing arm. The manual brake facilitates manual engagement of a brake of the tractive assembly.

Still another embodiment relates to a mobile high pressure air compressor system. The mobile high pressure air compressor system includes a trailer with a platform and a tractive assembly, a compressor assembly, a control system, and an enclosure. The compressor assembly is proximate a rear end and a first side of the platform. The compressor assembly includes an air driver positioned above the tractive assembly and proximate the first side of the platform, a compressor positioned rightward of the air driver, a conduit on a reel positioned rearward of the air driver, the compressor, and the tractive assembly and leftward of the air driver and the air compressor, a prime mover assembly positioned forward of the tractive assembly, the compressor, and the air driver, rightward of the compressor and the air driver, and proximate a front end of the platform, and a fuel assembly positioned proximate the front end and a second side of the platform. The control system is coupled to the platform rearward of the tractive assembly and proximate the second side of the platform and controls operation of the compressor assembly. The enclosure extends along the platform, houses the compressor assembly and the control system. The enclosure includes a number of doors providing access to components housed in the enclosure. The enclosure includes permeable panels allowing airflow through the enclosure to ventilate the compressor assembly.

This summary is illustrative only and is not intended to be in any way limiting. Other aspects, inventive features, and advantages of the devices or processes described herein will become apparent in the detailed description set forth herein, take in conjunction with the accompanying figures, wherein like reference numerals refer to like elements.

### BRIEF DESCRIPTION OF THE DRAWINGS

FIG. 1 is a rear perspective view of a high pressure air compressor, according to an exemplary embodiment.

FIG. 2 is a front perspective view of the high pressure air compressor of FIG. 1, according to an exemplary embodiment.

FIG. 3 is a right side view of the high pressure air compressor of FIG. 1, according to an exemplary embodiment.

FIG. 4 is a left side view of the high pressure air compressor of FIG. 1, according to an exemplary embodiment.

FIG. 5 is a bottom view of the high pressure air compressor of FIG. 1, according to an exemplary embodiment.

FIG. 6 is a rear perspective view of the high pressure air compressor of FIG. 1 without a cover, according to an exemplary embodiment.

FIG. 7 is a detailed front perspective view of a portion of the high pressure air compressor of FIG. 1, according to an exemplary embodiment.

FIG. 8 is a perspective view of a compressor assembly of the high pressure air compressor of FIG. 1, according to an exemplary embodiment.

FIG. 9 is a perspective view of a control system of the high pressure air compressor of FIG. 1, according to an exemplary embodiment.

FIG. 10A-10D are various views of graphical user interfaces of the control system of FIG. 9, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### High Pressure Air Compressor

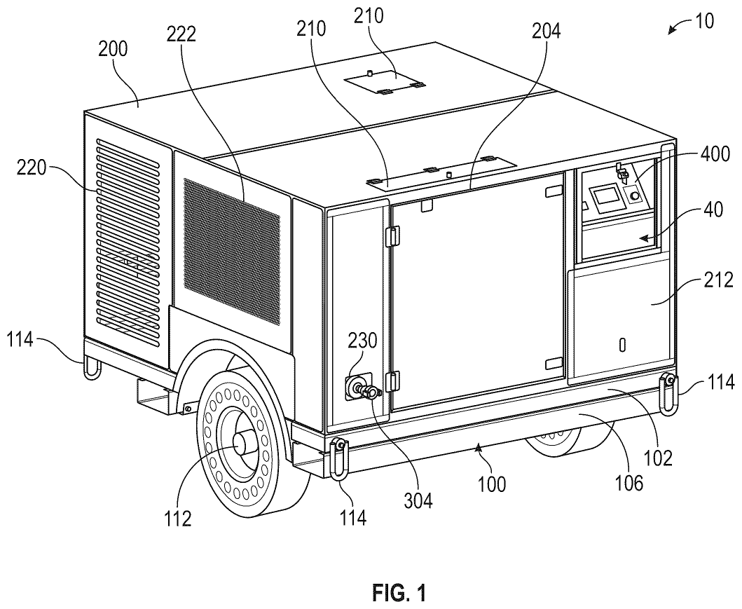

As shown in FIG. 1-9, a high pressure air compressor (“HIPAC”) system, shown as HIPAC system 10, includes a compressor assembly, shown as compressor assembly 30, a control assembly, shown as control system 40, a trailer assembly, shown as trailer 100, and a housing or cover, shown as enclosure 200, disposed around and on top of the trailer 100. The trailer 100 includes a deck (e.g., a flat, level surface configured to support a large load and provide components with a mounting surface), shown as platform 102, having a first end, shown as front end 104, a second end, shown as rear end 106, opposite the front end 104, a first side, shown as left side 108, and a second side, shown as right side 110, opposite the left side 108.

According to an exemplary embodiment, the trailer 100 includes a plurality of components (e.g., an axle, tie downs, a jack, a tow bar, etc.) configured to facilitate the transportability of the trailer 100. As shown in FIG. 1-6, the trailer 100 includes a tractive assembly, shown as trailer axle 112, coupled to an underside of the platform 102 between the front end 104 and the rear end 106. The trailer axle 112 includes two tractive elements (e.g., wheels) and a shaft member (e.g., a strut, post, rod, etc.) coupled between the wheels. The trailer axle 112 is configured to facilitate movement (e.g., towing, etc.) of the trailer 100. In some embodiments, the trailer 100 includes a plurality of trailer axles 112 (e.g., a tandem axle). That is, the HIPAC system 10 includes one or more trailer axles 112 such that the HIPAC system 10 is mobile.

As shown in FIG. 1-7, the trailer 100 includes a tie down point, shown as tie down 114, positioned at each corner of the platform 102 such that there are two tie downs 114 coupled to the front end 104 of the platform 102 and two tie downs 114 coupled to the rear end 106 of the platform 102. The tie downs 114 may be configured to facilitate securing the HIPAC system 10 (e.g., within a plane, without a cargo container, on a larger tailer, etc.) during delivery and/or relocation from one location to another.

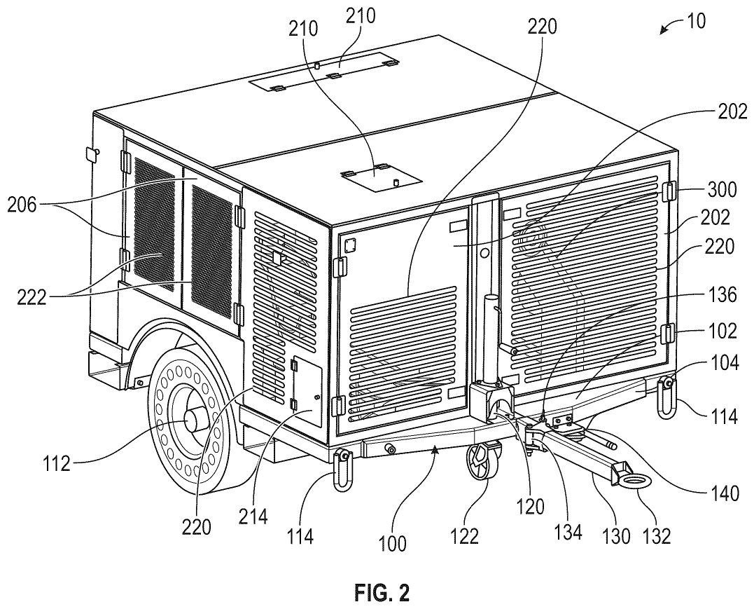

As shown in FIG. 2-5 and 7, the trailer 100 includes an extendable or deployable support, shown as extendable jack 120, having a wheel, shown as jack wheel 122, positioned at a lower end thereof. The extendable jack 120 is positioned proximate and coupled to the front end 104 of the platform 102. The extendable jack 120 is configured to selectively extend and retract such that the jack wheel 122 selectively engages a ground surface to raise and lower the front end 104 of the platform 102. The jack wheel 122 is configured to facilitate movement of the trailer 100 while being disconnected from a tow vehicle.

As shown in FIG. 2-7, the trailer 100 includes a towing arm, shown as tow bar 130, extending forward from the front end 104 of the platform 102. The tow bar 130 includes a towing interface, shown as tow hook 132, positioned at a free end of the tow bar 130. The tow hook 132 is configured to engage a trailer hitch (e.g., a hook connector, hitch ball, etc.) of a towing vehicle (e.g., a tractor, a truck, etc.). As shown in FIG. 2-5 and 7, the tow bar 130 includes a side-folding hinge, shown as tow bar hinge 134, pivotably coupling the tow bar 130 to the front end 104 of the platform 102. The tow bar hinge 134 allows the tow bar 130 to be moved through a range of motion having a first position where the tow bar 130 is oriented substantially perpendicular to the front end 104 of the platform 102 and a second position where the tow bar 130 is oriented substantially parallel to the front end 104 of the platform 102. In some embodiments, the tow hook 132 is positioned proximate the right side 110 of the platform 102 when the tow bar 130 is in the second position. For example, when the tow bar 130 is in the first position, the trailer 100 can be coupled to a towing vehicle and be transported by the towing vehicle. When the tow bar 130 is in the second position, the trailer 100 cannot be coupled to a towing vehicle. In some embodiments, the tow hook 132 is positioned proximate the left side 108 of the platform 102 when the tow bar 130 is in the second position. As shown in FIG. 2-5 and 7, the tow bar 130 includes a retainer, shown as locking pin 136, mounted opposite the tow bar hinge 134. According to an exemplary embodiment, the locking pin 136 is configured to selectively secure the position of the tow bar 130. By way of example, when the locking pin 136 is inserted into an interface between the platform 102 and the tow bar 130, the tow bar 130 is secured (e.g., locked, etc.) in the first position. By way of another example, when the locking pin 136 is removed from the interface between the platform 102 and the tow bar 130, the tow bar 130 may be free to pivot to the second position.

As shown in FIGS. 2, 4, 5, and 7, the trailer 100 includes a manual brake, shown as parking brake 140, coupled to the front end 104 of the platform 102. In other embodiments, the parking brake 140 is otherwise positioned (e.g., at the rear end 106, on a side of the platform 102, etc.). According to an exemplary embodiment, the parking brake 140 includes a lever configured to facilitate engaging and disengaging a brake of the trailer axle 112, preventing or permitting the rotation/movement thereof.

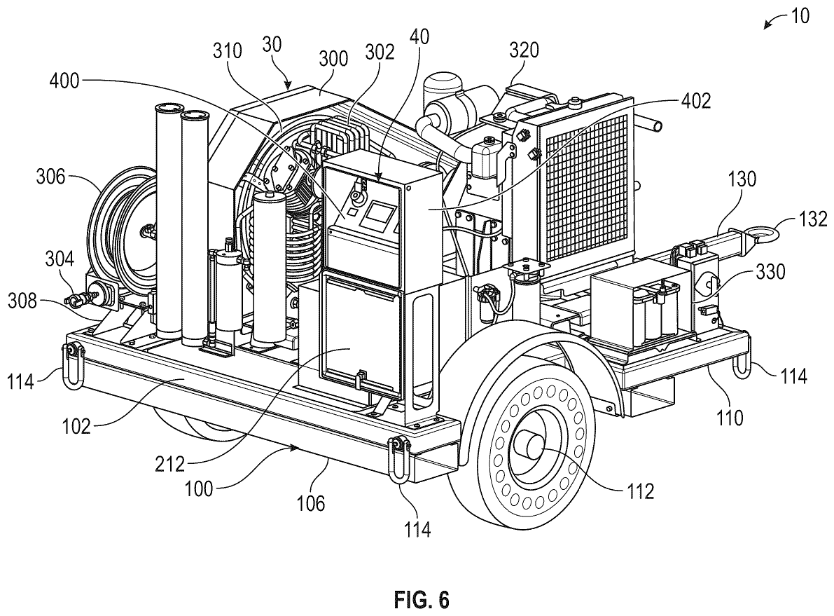

As shown in FIG. 6, the compressor assembly 30 is supported by the platform 102. As shown in FIG. 2-4, 6, and 8, the compressor assembly 30 includes a compressor, shown as compressor 302, and an air driver, shown as fan 310, coupled to the platform 102 with a shroud, shown as fan housing 300, coupled to the platform 102 and at least partially extending around the compressor 302 and/or the fan 310. The fan housing 300, the fan 310, and the compressor 302 are positioned above the trailer axle 112 and proximate the rear end 106 and the left side 108 of the platform 102. According to an exemplary embodiment, the compressor 302 is configured to intake environmental air and compress such air, increasing the pressure thereof (e.g., to a high pressure). The fan 310 is positioned to provide airflow to the compressor 302 to facilitate regulating a temperature of the compressor 302.

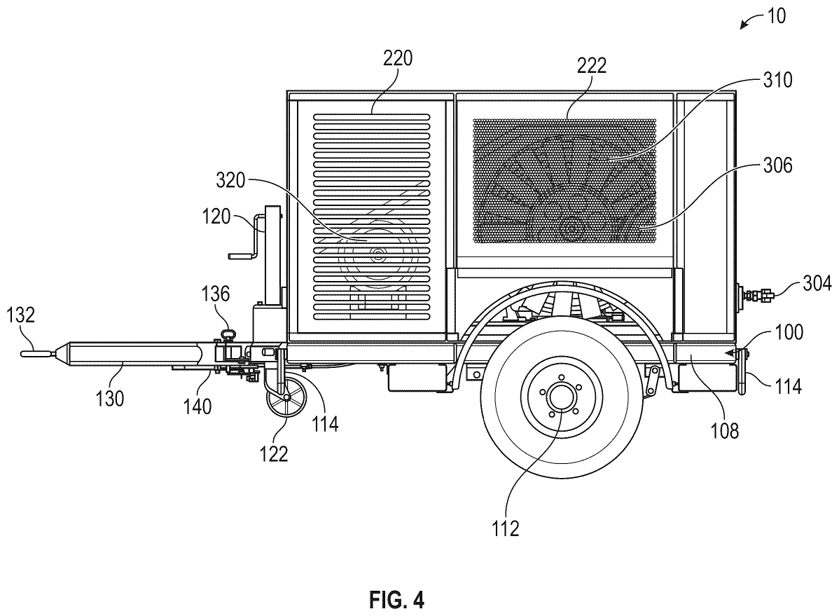

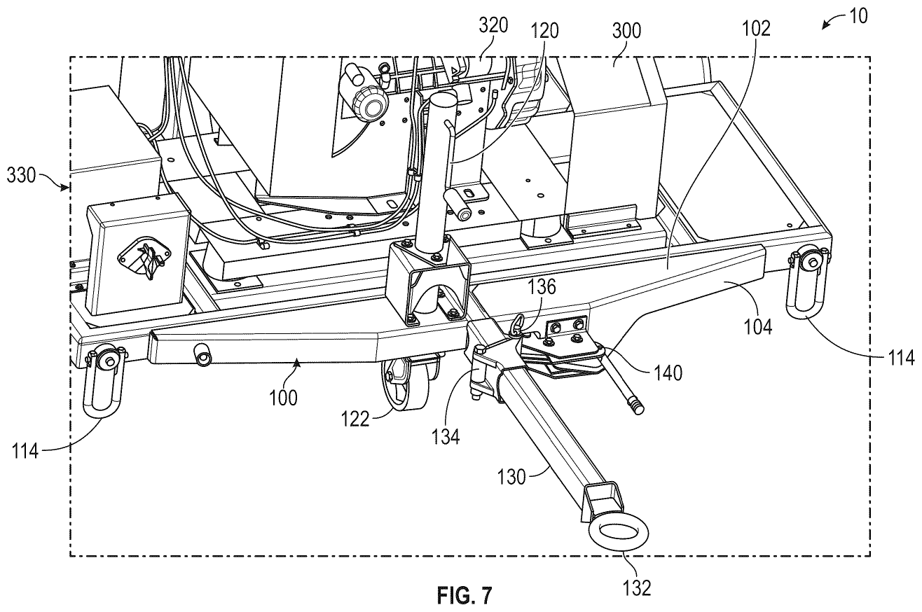

As shown in FIGS. 4 and 7, the compressor assembly 30 includes a conduit, shown as air hose 304, a reel, shown as hose reel 306, around which the air hose 304 is wound and housed, and a bracket, shown as reel mount 308, rotationally coupling the hose reel 306 to the to the platform 102. According to an exemplary embodiment, the air hose 304 is fluidly coupled to the compressor 302 and configured to facilitate providing pressurized air from the compressor 302 to a desired destination (e.g., an aircraft, a plane, a jet, etc.). As shown in FIG. 6, the reel mount 308 is coupled to the platform 102 (a) at least partially rearward of the fan housing 300, the compressor 302, the fan 310, and the trailer axle 112 and (b) closer to the left side 108 of the trailer 100.

As shown in FIGS. 4 and 6-8, the compressor assembly 30 includes a prime mover assembly, shown as engine assembly 320. The engine assembly 320 may include a prime mover or an engine, a heat exchanger or intercooler, and/or a power transfer system (e.g., a transmission, a gearbox, a pulley system, etc.). As shown in FIGS. 4 and 6, the engine assembly 320 is supported by the platform 102 and positioned (a) at least partially forward of the trailer axle 112, the compressor 302, and the fan 310, (b) at least partially offset rightward of the compressor 302 and the fan 310, and (c) proximate the front end 104 of the platform 102. According to an exemplary embodiment, the engine assembly 320 is configured to drive the compressor 302 and/or the fan 310 (e.g., via the power transfer system) to facilitate the operation thereof.

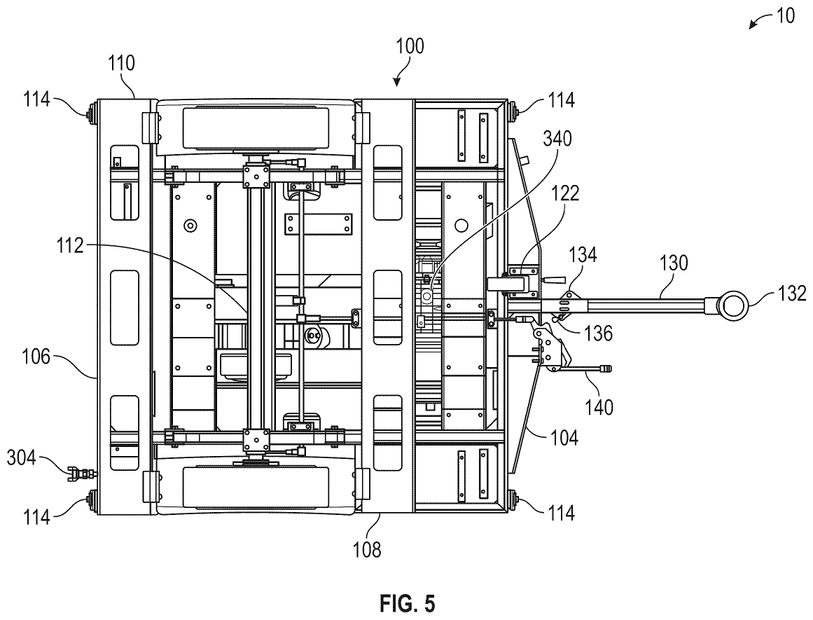

As shown in FIG. 6, the compressor assembly 30 includes a fuel assembly, shown as fuel system 330. The fuel system 330 is coupled to the platform 102 proximate the corner at the front end 104 and the right side 110 of the platform 102. The fuel system 330 is fluidly coupled to the engine assembly 320. In some embodiments, the engine of the engine assembly 320 is an internal combustion engine configured to receive fuel (e.g., gasoline, diesel, propane, etc.) from the fuel system 330 to facilitate combustion and outputting mechanical energy to the compressor 302. As shown in FIG. 5, the engine assembly 320 includes a drain valve, shown as oil drain valve 340, positioned below the engine assembly 320 that is accessible through an access opening defined by the platform 102, proximate the front end 104 thereof.

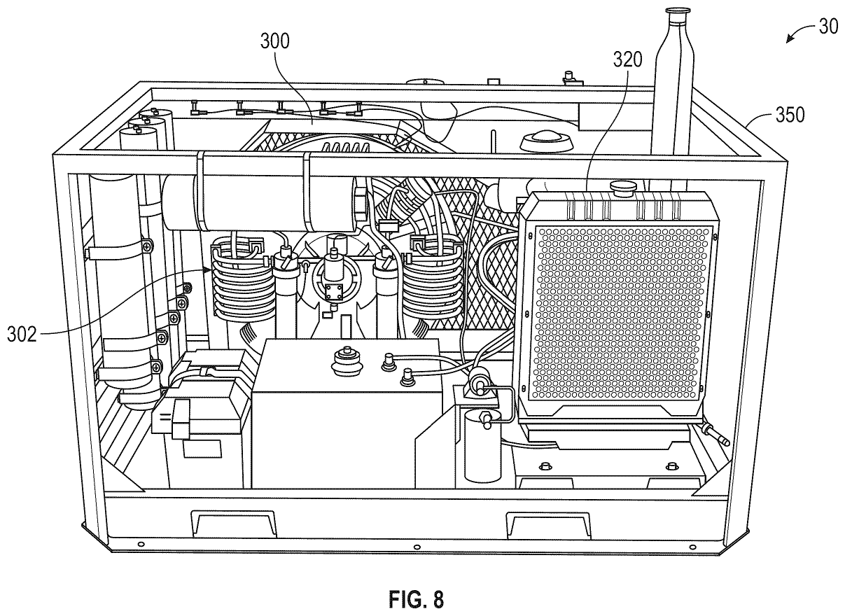

In some embodiments, as shown in FIG. 8, the compressor assembly 30 includes a frame, shown as frame assembly 350, configured to receive and hold the fan housing 300, the compressor 302, the fan 310, and/or the engine assembly 320. According to an exemplary embodiment, the frame assembly 350 is configured to provide a plurality of mounting location to mount the compressor assembly 30 to the platform 102 of the trailer 100. Therefore, the frame assembly 350 facilitates assembling the compressor assembly 30 separate from the trailer 100 and installing the fan housing 300, the compressor 302, the fan 310, and the engine assembly 320 in one sub-assembly. In some embodiments, the fuel system 330 is additionally received by the frame assembly 350. In some embodiments, the compressor assembly 30 does not include the frame assembly 350. In such embodiments, the fan housing 300, the compressor 302, the fan 310, and/or the engine assembly 320 may be directly and individually coupled to the platform 102.

As shown in FIGS. 1, 6, and 9, the control system 40 includes a panel, shown as control panel 400, and a panel housing, shown as control system housing 402, within which the control panel 400 is supported and housed. As shown in FIG. 6, the control system housing 402 is coupled to the platform 102 proximate the corner at by the rear end 106 and the right side 110 of the platform 102 such that the control panel 400 is accessible by an operator while positioned rearward the trailer 100.

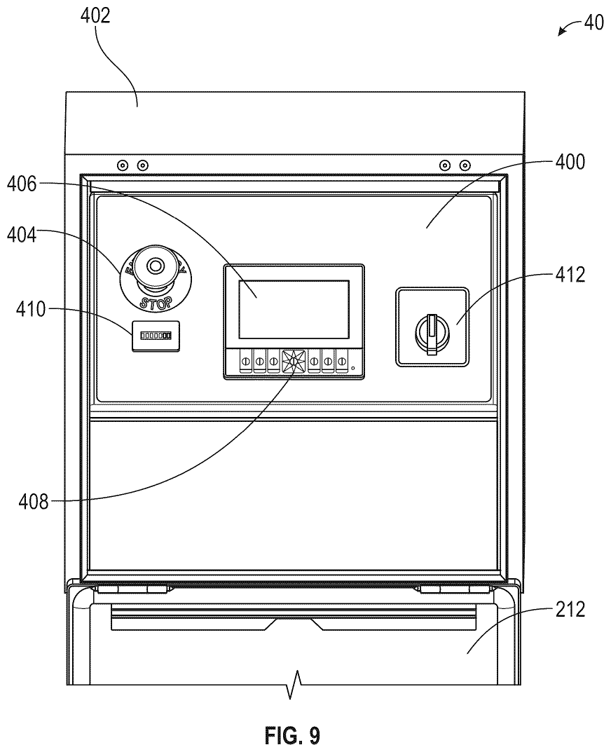

According to an exemplary embodiment, the control panel 400 is configured to provide an operator with the ability to control one or more functions of and/or provide commands to the HIPAC system 10 and the components thereof (e.g., turn on, turn off, engage various operating modes, discharge air, etc.). For example, the control panel 400 is communicably coupled to the compressor assembly 30 and configured to at least partially control the operation thereof. As shown in FIG. 9, the control panel 400 includes a plurality of input and output devices including an emergency stop interface, shown as emergency stop 404, a display interface including a display screen, shown as display 406, and one or more input devices (e.g., buttons, switches, knobs, dials, etc.), shown as user inputs 408, a use meter, shown as engine hour meter 410, and an start/stop interface, shown as engine start/stop 412.

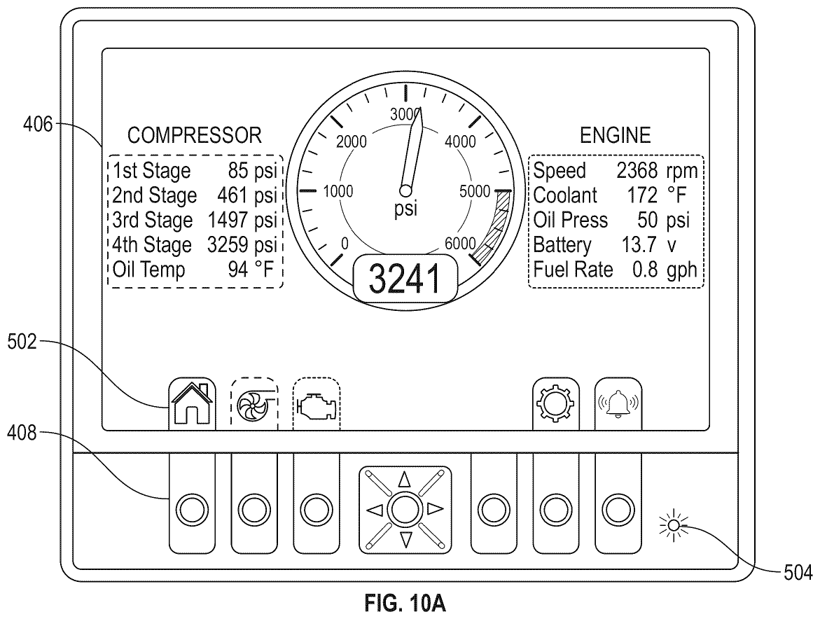

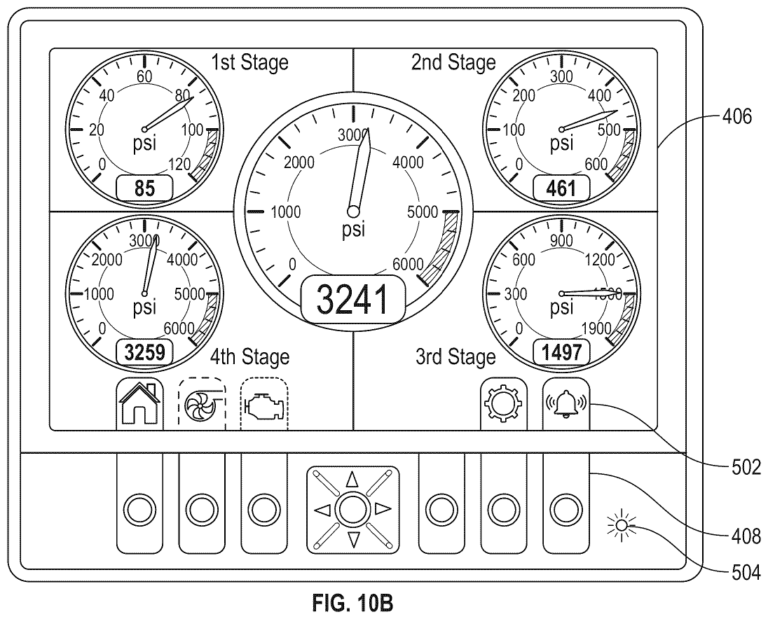

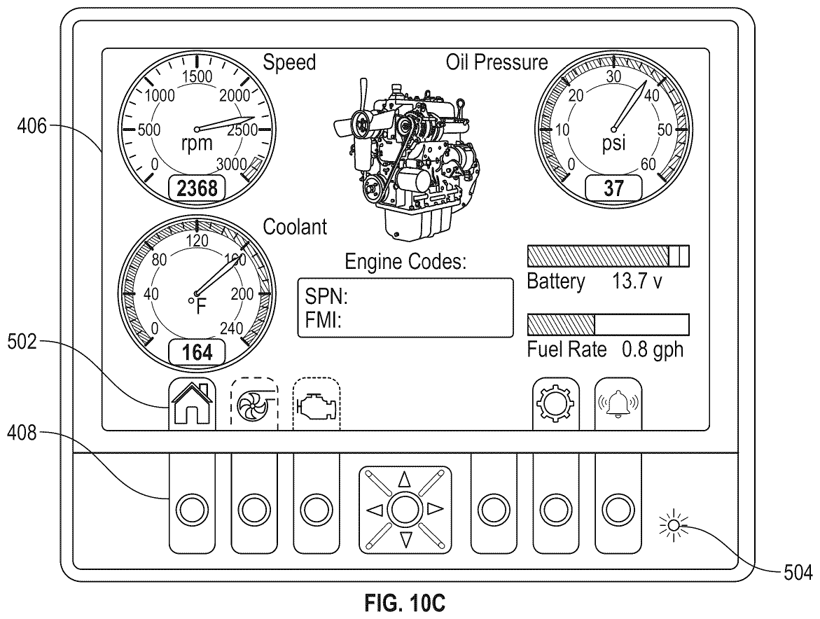

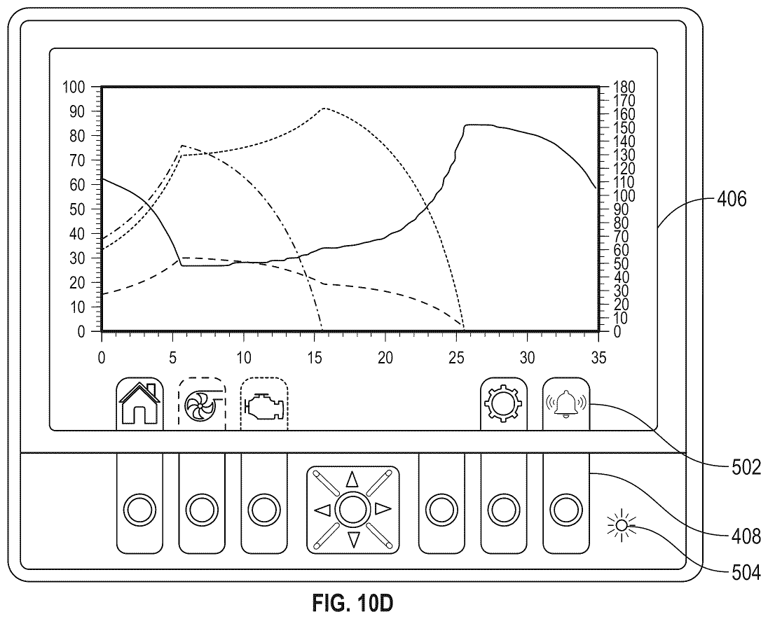

In some embodiments, the emergency stop 404 is a push-button configured to be moved between a first and a second position by an operator engaging the push-button where the first position is a stand-by position with the emergency stop 404 disengaged (i.e., in a raised position) and the second position is a deployed position with the emergency stop 404 engaged (i.e., depressed). The control system 40 is configured to cease operation of the HIPAC system 10 responsive to receiving an indication that the emergency stop 404 is in the deployed position (i.e., engaged). The display 406 may be or include a touchscreen, an LCD display, a LED display, a graphical user interface, warning lights, etc. The display 406 may be configured to display information and/or warnings relating to the operation of the HIPAC system 10 (see, e.g., FIG. 10A-10D). The engine hour meter 410 be a gauge or a display (e.g., an analog display, a digital display, an LCD screen, an LED screen, etc.) configured to display a series of numbers providing operators a real-time indication of the amount of time the engine assembly 320 has operated.

The engine start/stop 412 may be a knob configured to be rotated by an operator between (a) a first or off position providing the control system 40 an indication that the engine assembly 320 should be stopped and (b) a second or a on position providing the control system 40 an indication that the engine assembly 320 should be started or continue running. The control system 40 is configured to operate the engine assembly 320 based on signals received regarding the position of the engine start/stop 412. For example, upon receiving an indication that the engine start/stop 412 is in the on position, the control system 40 will send a command to the engine assembly 320 to turn on, driving the operation of the compressor 302 and/or the fan 310.

As shown in FIG. 1-5, the enclosure 200 includes a plurality of panels coupled to the platform 102 to enclose the compressor assembly 30 and the control system 40 therein. For example, the enclosure 200 is configured to enclose and protect one or more components of the HIPAC system 10 from one or more environmental conditions. The enclosure 200 includes one or more front doors, shown as front access doors 202, positioned at the front end 104 of the platform 102, one or more rear doors, shown as rear access door 204, positioned proximate the rear end 106 of the platform 102, one or more right side doors, shown as right side access doors 206, positioned proximate the right side 110 of the platform 102, and one or more roof doors, shown as roof access doors 210, positioned along the roof of the enclosure 200. According to an exemplary embodiment, the front access doors 202, the rear access door 204, the right side access doors 206, and the roof access doors 210 are configured to pivot open and closed to access the various components within the enclosure 200 for inspection, cleaning, maintenance, repair, and/or replacement. In some embodiments, the front access doors 202, the rear access door 204, the right side access doors 206, and/or the roof access doors 210 include locking mechanisms (e.g., a sliding latch, a rotating latch, a lock, a lock set, etc.) configured to facilitate selectively locking the front access doors 202, the rear access door 204, the right side access doors 206, and/or the roof access doors 210.

As shown in FIG. 1-4, various panels of the enclosure 200 and the front access doors 202 define various opening or slots, shown as louvers 220. As shown in FIG. 1-4, various panels of the enclosure 200 and the right side access doors 206 include a permeable panel, shown as mesh panel 222. According to an exemplary embodiment, the louvers 220 and the mesh panels 222 are configured to allow airflow into and out of the enclosure 200 such that the components of the compressor assembly 30 can draw fresh, cool air into the enclosure and reject warm, used air out of the enclosure 200, regulating the temperature thereof.

As shown in FIG. 1, the enclosure 200 includes a control system access door, shown as control panel access door 212, configured to provide an operator access to a portion of the control panel 400. In some embodiments, the control panel access door 212 includes a locking latch configured to selectively secure the control panel access door 212 in a closed/locked position. As shown in in FIG. 6, the control panel access door 212 provides access to a chamber of the control system housing 402. The control system housing 402 may house a power source (e.g., a power supply, an electric machine, etc.), processing circuity, etc. configured to supply electrical energy to and control the components of the control panel 400. In some embodiments, the control panel access door 212 provides access to a storage compartment. In some embodiments, the enclosure 200 includes a sliding or rollable panel that selectively extends across the control panel 400.

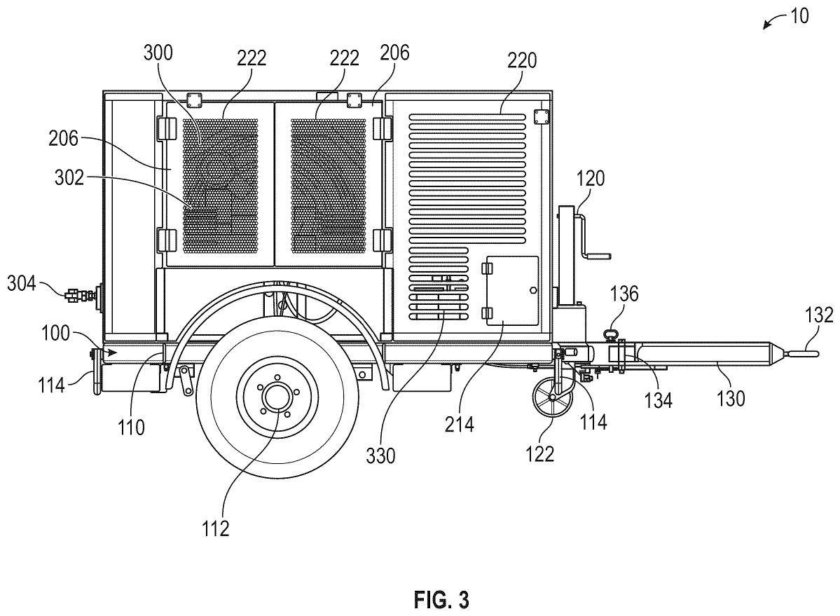

As shown in FIGS. 2 and 3, the enclosure 200 includes a fueling access door, shown as fuel system access door 214, configured to provide an operator access to the fuel system 330. As shown in FIG. 1, the enclosure includes an opening, shown as hose port 230, configured to allow access to air hose 304 without requiring an operator to open any doors of the enclosure 200. The hose port 230 is positioned proximate the rear end 106 of the platform 102, proximate the left side 108 thereof such that the air hose 304 at least partially extends through the hose port 230.

### Control System

In some embodiments, the control system 40 is configured to send and receive signals to and from the compressor assembly 30 in order to operate the compressor assembly 30. Upon receiving an indication that an operator is operating the compressor assembly 30, the control system 40 is configured to start operation the engine assembly, causing the engine assembly 320 to receive fuel from the fuel system 330 and combust the fuel to generate mechanical power. The generated mechanical power is provided from the engine assembly 320 to the compressor 302 and/or the fan 310. The compressor 302 receives and pressurizes air. The pressurized air may then be stored within a tank or reservoir associated with the compressor 302 until an operator provides an indication to send the compressed air to the air hose 304, where it can be accessed by an operator and applied to a task.

As shown in FIG. 10A-10D, the display 406 provides various graphical user interfaces (“GUIs”), shown as GUIs 502, and includes an indicator, shown as LED 504. The GUIs 502 may include or provide a navigation menu having various soft keys to facilitate navigating the GUIs 502. The GUIs 502 may be configured to provide an operator with an indication of one or many relevant information and/or warnings relating to the operation of the HIPAC system 10 (e.g., air pressure, oil temp, engine speed, oil pressure, state of charge, emergency stop position, etc.). The LED 504 may be configured to provide an indication regarding the state of the HIPAC system 10. For example, the LED 504 may display green as an indication of the HIPAC system 10 currently being operated and/or red if there is a current fault or issue.

As shown in FIG. 10A, a first GUI 502 provides one or more indications regarding the state of the compressor assembly 30. Such indications may include: in a first, leftmost section, one or more indications of the air pressure at various phases of the compression process and an indication of the oil temperature of the compressor 302; in a second, center section, an indication of the real-time output air pressure of the compressor 302; and in a third, rightmost section, one or more indications regarding the state of the engine assembly 320 including speed of the engine, coolant temperature, oil pressure, battery voltage, and fuel consumption.

As shown in FIG. 10B, a second GUI 502 provides one or more indications regarding the state of the compressor 302. Such indications may include: in a first, leftmost section, one or more indications of the air pressure at various phases of the compression process; in a second, center section, an indication of the real-time outlet air pressure of the compressor 302; and in a third, rightmost section, one or more indications of the air pressure at various other phases of the compression process.

As shown in FIG. 10C, a third GUI 502 provides one or more indications regarding the state of the engine assembly. Such indications may include: in a first, leftmost section, one or more indications including speed of the engine and coolant temperature; in a second, center section, one or more indications regarding the engine codes; and in a third, rightmost section, one or more indications including oil pressure, battery voltage, and fuel consumption.

As shown in FIG. 10D, a fourth GUI 502 provides one or more indications regarding one or more operating trends-over-time regarding operation of the HIPAC system 10. In some other embodiments, the control system 40 may be configured to enable a manual input/output testing mode wherein the display 406 and the user inputs 408 can be operated to test various components of the HIPAC system 10. In yet another embodiment, the display 406 may be configured to display an alarm history screen, providing an indication of the performance/fault history of the HIPAC system 10.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled,” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the HIPAC system 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A high pressure air compressor system comprising:
a trailer including:
a platform;
a tractive assembly coupled to the platform;
a compressor assembly supported by the platform;
a fuel assembly coupled to the platform and fluidly coupled to the compressor assembly;
a control panel communicably coupled to the compressor assembly, the control panel supported by the platform; and
an enclosure extending along the platform with the compressor assembly and the fuel assembly disposed therein.

2. The high pressure air compressor system of claim 1, wherein the control panel is configured to:
receive a plurality of user inputs regarding the operation of the compressor assembly;
operate the compressor assembly in response to receiving an operator input;
provide a user with an indication of the current state of the high pressure air compressor system; and
provide a user with an indication of the usage of the high pressure air compressor system.

3. The high pressure air compressor system of claim 1, wherein the enclosure is a selectively removable cover configured to protect one or more components of the high pressure air compressor system.

4. The high pressure air compressor system of claim 1, wherein the enclosure includes:
one or more front doors positioned proximate a front end of the platform, the one or more front doors configured to provide a user access to one or more components of the high pressure air compressor system positioned within the enclosure;
one or more side doors positioned proximate a side of the platform, the one or more side doors configured to provide the user access to one or more components of the high pressure air compressor system positioned within the enclosure;
one or more rear doors positioned proximate a rear end of the platform, the one or more rear doors configured to provide the user access to one or more components of the high pressure air compressor system positioned within the enclosure; and
one or more roof doors positioned along a roof of the enclosure, the one or more roof doors configured to provide the user access to one or more components of the high pressure air compressor system positioned within the enclosure.

5. The high pressure air compressor system of claim 4, wherein the enclosure includes a plurality of locking mechanisms configured to selectively lock at least one of the one or more front doors, the one or more side doors, the one or more rear doors, or the one or more roof doors.

6. The high pressure air compressor system of claim 1, wherein the trailer includes:
an extendable jack configured to raise and lower the trailer;
a jack wheel coupled to the extendable jack and configured to facilitate moving the trailer when the trailer is disconnected from a tow vehicle;
a towing arm pivotably coupled to a front end of the platform and configured to be rotated between a plurality of positions;
a towing interface coupled to the towing arm, the towing interface configured to engage an element of the tow vehicle to couple the trailer to the tow vehicle;
a side-folding hinge configured to facilitate rotation of the towing arm;
a retainer configured to facilitate selectively securing the position of the towing arm; and
a manual brake configured to facilitate manual user engagement of a brake of the tractive assembly.

7. The high pressure air compressor system of claim 1, wherein the compressor assembly includes:
a compressor configured to intake air from the environment and compress the air into pressurized air;
an air driver configured to provide airflow to the compressor to facilitate regulating a temperature of the compressor;
a conduit fluidly coupled to the compressor and configured to facilitate providing the pressurized air from the compressor to a desired destination; and
a reel around which the conduit is wound and housed.

8. The high pressure air compressor system of claim 7, wherein the compressor assembly includes an internal combustion engine configured to drive at least one of the compressor or the air driver.

9. The high pressure air compressor system of claim 1, wherein the enclosure includes:
a plurality of permeable panels configured to allow airflow into and out of the enclosure to regulate a temperature of the compressor assembly; and
a plurality of non-permeable panels configured to cover and protect one or more components of the high pressure air compressor system from environmental conditions.

10. The high pressure air compressor system of claim 9, wherein the plurality of permeable panels include at least one mesh panel and at least one panel having a plurality of louvers.

11. The high pressure air compressor system of claim 1, further comprising:
a control panel housing configured to house and support the control panel;
a control panel access door configured to provide access to the control panel;
an emergency stop interface configured to receive one or more user inputs and cease operation of the compressor assembly;
a display configured to provide a plurality of graphical user interfaces, the plurality of graphical user interfaces configured to:
provide a user an indication regarding a current state of the high pressure air compressor system;
receive a plurality of user inputs regarding the operation of the high pressure air compressor system; and
provide a user with an indication of a state of the high pressure air compressor system over a period of time;
a use meter configured to provide a user with an indication of an amount of time the high pressure air compressor system has operated;
one or more input devices configured to receive one or more of the plurality of inputs from the user regarding the operation of the high pressure air compressor system; and
a start/stop interface configured to be movable between a first position and a second position by a user to turn the high pressure air compressor system on and off.

12. An air compressor system comprising:
a platform including a front end and a rear end;
a tractive assembly coupled to the platform;
a compressor assembly supported by the platform, the compressor assembly configured to generate and provide pressurized air, the compressor assembly comprising:
a compressor configured to intake air from the environment and compress the air into a higher pressure;
an air driver configured to provide airflow to the compressor to facilitate regulating a temperature of the compressor;
a prime mover configured to drive at least one of the compressor or the air driver;
a conduit fluidly coupled to the compressor and configured to facilitate providing pressurized air from the compressor to a desired destination; and
a reel around which the conduit is wound and housed;
a control system configured to control operation of the air compressor system, the control system including a control panel configure to provide a user with the ability to control one or more functions of the air compressor system;
an enclosure supported by the platform, wherein the compressor assembly is disposed withing the enclosure, and wherein a free end of the conduit extends through an aperture defined by the enclosure;
a towing arm pivotably coupled to the front end of the platform;
a side-folding hinge configured to facilitate rotation of the towing arm, wherein the towing arm is rotatable between (a) a first position where the towing arm is oriented substantially perpendicular to the front end of the platform and (b) a second where the towing arm is oriented substantially parallel to the front end of the platform; and
a manual brake positioned proximate the towing arm, the manual brake configured to facilitate manual user engagement of a brake of the tractive assembly.

13. The air compressor system of claim 12, wherein the compressor or the air driver are positioned directly vertically above an axle of the tractive assembly and proximate the rear end.

14. The air compressor system of claim 12, wherein the compressor assembly includes a frame supported by the platform, the frame supporting the air driver, the compressor, and the prime mover.

15. The air compressor system of claim 12, further comprising a reel mount configured to couple the reel to the platform, wherein the reel is positioned proximate the rear end of the platform.

16. A mobile high pressure air compressor system comprising:
a trailer including a platform and a tractive assembly coupled to the platform;
a compressor assembly supported by the platform proximate a rear end and a first side of the platform, the compressor assembly configured to pressurize air, the compressor assembly including:
an air driver coupled to the platform and positioned vertically above the tractive assembly and proximate the first side of the platform;
a compressor positioned at least partially rightward of the air driver;
a conduit wound about a reel, the reel coupled to the platform by a bracket, the bracket positioned rearward of the air driver, the compressor, and the tractive assembly and leftward of the air driver and the compressor;
a prime mover assembly positioned forward of the tractive assembly, the compressor, and the air driver, rightward of the compressor and the air driver, and proximate a front end of the platform; and
a fuel assembly coupled to the platform proximate the front end and a second side of the platform;
a control system coupled to the platform rearward of the tractive assembly and proximate the second side of the platform, the control system configured to control operation of one or more components of the compressor assembly; and
an enclosure extending along the platform, the enclosure configured to house the compressor assembly and the control system, the enclosure including:
one or more front doors positioned proximate the front end of the platform, the one or more front doors configured to provide a user access to one or more components housed in the enclosure;
one or more second side doors positioned proximate the second side of the platform, the one or more second side doors configured to provide the user access to one or more components housed in the enclosure;
one or more rear doors positioned proximate the rear end of the platform, the one or more rear doors configured to provide the user access to one or more components housed in the enclosure;
one or more roof doors positioned along a roof of the enclosure, the one or more roof doors configured to provide the user access to one or more components housed in the enclosure; and
a plurality of permeable panels configured to allow air to flow into and out of the enclosure, thereby ventilating the compressor assembly.

17. The mobile high pressure air compressor system of claim 16, wherein the trailer includes:
an extendable jack positioned proximate the front end of the platform, the extendable jack configured to selectively raise and lower the trailer;
a jack wheel coupled to the extendable jack and configured to facilitate moving the trailer when the trailer is disconnected from a tow vehicle;
a towing arm pivotably coupled to the front end of the platform and configured to be rotated between a plurality of positions;
a towing interface coupled to the towing arm, the towing interface configured to engage an element of the tow vehicle to couple the trailer to the tow vehicle;
a side-folding hinge configured to facilitate rotation of the towing arm;
a retainer configured to facilitate selectively securing the position of the towing arm; and
a manual brake configured to facilitate manual user engagement of a brake of the tractive assembly.

18. The mobile high pressure air compressor system of claim 17, wherein the towing arm is rotatable between a first position and a second position, wherein:
when in the first position, the towing arm is oriented substantially perpendicular to the front end of the platform; and
when in the second position, the towing arm is oriented substantially parallel to the front end of the platform.

19. The mobile high pressure air compressor system of claim 16, wherein a free end of the conduit extends through an aperture defined by the enclosure.

20. The mobile high pressure air compressor system of claim 16, wherein at least one of the one or more front doors, the one or more rear doors, or the one or more side doors includes at least one of the plurality of permeable panels.
